(19) United States
(12) Patent Application Publication
(10) Pub. No.: US 2026/0228979 A1
(43) Pub. Date: Aug. 6, 2026

(54) System and Method for Adaptive Virtual Reality Assistance with Real-Time Companion Intelligence

(71) Applicant: SEBASTIAAN CONRAD ASTON-MARTIN VAN NUISSENBURG, BRISBANE (AU)

(72) Inventor: SEBASTIAAN CONRAD ASTON-MARTIN VAN NUISSENBURG, BRISBANE (AU)

(21) Appl. No.: 19/046,559

(22) Filed: Feb. 6, 2025

(51) Int. Cl. G06T 19/00; G06F 3/01; G06T 15/10; G06T 15/60; G06V 10/82; G06V 40/16; G06V 40/20; G10L 15/16; G10L 15/18; H04L 9/00; H04L 9/08

(52) U.S. Cl. CPC G06T 19/00; G06T 15/10; G06T 15/60; G06F 3/015; G06T 2219/024; G06V 10/82; G06V 40/174; G06V 40/20; G10L 15/16; G10L 15/18; H04L 9/0852; H04L 9/50

(57) ABSTRACT

A system provides adaptive assistance through virtual reality and artificial intelligence. The system includes a data acquisition module receiving multimodal input data from sensors, a virtual reality module generating an interactive virtual environment, and a processor that processes the input data to generate user state data and virtual companion data. The processor dynamically modifies parameters of the virtual environment based on processed data. A memory stores input data, processed data, behavioral models, and environment configuration data. A backend platform processes and transmits data to remote devices through a communication interface. The virtual reality module renders a virtual companion within the interactive virtual environment according to the virtual companion data and modifies the environment based on processed parameters. This system architecture enables real-time adaptation of both the virtual companion and virtual environment in response to user interactions and states.

### FIELD OF INVENTION

The present invention relates to the field of assistive technology systems, and more particularly to virtual reality-based assistance systems that incorporate artificial intelligence. The invention specifically pertains to systems that process multimodal user input data to provide adaptive virtual assistance through a dynamically modified virtual environment and companion.

### BACKGROUND

Existing assistive technologies aimed at supporting individuals with disabilities have made significant strides in recent years, leveraging artificial intelligence (AI), virtual reality (VR), and machine learning (ML) to enhance accessibility and provide task-specific guidance. However, despite these advancements, current solutions remain constrained by their lack of real-time adaptability, emotional intelligence integration, and task-specific reinforcement learning. Many commercially available AI-driven assistants and VR-based training tools rely on preprogrammed responses and static learning models, which fail to adjust dynamically to an individual's evolving needs. As a result, users often experience frustration, disengagement, and inefficiencies when attempting to perform tasks that require personalized, real-time guidance. The inability of these systems to interpret user frustration, detect skill progression, or modify task difficulty in real time presents a substantial limitation for individuals who require adaptable and interactive assistance tailored to their unique cognitive and emotional states.

Existing VR-based training systems similarly exhibit fundamental shortcomings in task adaptability and personalized user interaction. Many VR solutions designed for skill-building or therapeutic support operate on rigid training frameworks that do not evolve based on user engagement or performance metrics. These systems often utilize predefined training modules that lack the capability to recognize when a user is struggling, when they need motivation, or when they have demonstrated proficiency sufficient to advance to more complex tasks. Additionally, real-time feedback mechanisms in such VR environments are typically scripted rather than dynamically generated, limiting their effectiveness for individuals requiring continuous, context-aware guidance. Without the ability to adjust training parameters dynamically, such systems remain passive rather than interactive, leaving users unable to fully benefit from immersive assistive technology.

Another limitation of conventional AI-powered assistive tools is their inability to integrate multimodal emotional intelligence for real-time adaptation. While some AI-based systems incorporate sentiment analysis through text or voice-based inputs, they lack comprehensive multimodal recognition capabilities that assess facial expressions, physiological signals, and behavioral patterns to gauge a user's emotional state. The absence of a context-aware, real-time emotional intelligence processing system means that existing AI-driven assistive solutions often fail to intervene at the right moment, either providing excessive assistance when it is unnecessary or failing to provide encouragement when a user is struggling. This rigid, non-adaptive user engagement model significantly reduces the effectiveness of AI-driven guidance for individuals requiring real-time emotional support alongside task assistance.

One particularly relevant prior art reference, CN115494941A, discloses an AI-driven virtual human system within a metaverse environment, designed to provide customizable emotional companionship using natural language processing (NLP) and neural network-based avatar learning. While this system offers personalized conversational interaction and reinforcement learning-based emotional responses, it does not disclose or suggest a VR-centric training system that provides real-time, interactive task coaching. The reference focuses on social and emotional engagement rather than structured task-based assistance, and it lacks adaptive task modification, real-time performance-based learning adjustments, and integration with multimodal biometric inputs for task-specific training. Additionally, CN115494941A does not describe a reinforcement learning engine that iteratively improves training outcomes based on user progress, nor does it address how users transition between training phases based on engagement levels or emotional state analysis. These omissions underscore the fundamental gap in prior art concerning AI-driven real-time adaptive skill-building and interactive VR-based task training.

Furthermore, existing assistive systems often fail to balance real-time intervention with asynchronous self-paced learning, leading to either excessive reliance on live instruction or rigid self-guided modules that do not adapt based on user proficiency. Current VR-based training environments provide limited options for hybrid learning, where users can transition seamlessly between AI-assisted real-time instruction and self-paced training sessions. This rigid separation of training modes prevents a truly personalized learning experience that adjusts dynamically to a user's strengths, weaknesses, and engagement levels over time. Without the ability to combine structured AI-driven real-time guidance with independent practice sessions informed by reinforcement learning, users are left with either overwhelming, instructor-driven environments or impersonal, one-size-fits-all training sequences. These deficiencies highlight the need for an intelligent, adaptive, and emotionally aware assistive system capable of real-time task adjustment and personalized training progression.

It is within this context that the present invention is provided.

### SUMMARY

The present invention provides a system for adaptive assistance utilizing virtual reality and artificial intelligence technologies. The system includes a data acquisition module that receives multimodal input data from sensors, a virtual reality module that generates an interactive virtual environment, and a processor that processes the input data to generate user state data and virtual companion data. The processor dynamically modifies parameters of the virtual environment based on the processed data, while a memory stores the various data types and behavioral models. A backend platform processes and transmits data to remote devices, enabling distributed functionality and remote access.

This system architecture enables real-time adaptation of both the virtual companion and the virtual environment in response to user interactions and states. The integration of data acquisition, processing, and virtual reality generation allows for responsive and personalized assistance, while the backend platform facilitates data management, analysis, and remote collaboration.

In some embodiments, the system processes multiple types of input data including audio, visual, motion, and biometric data from various sensors. This comprehensive data collection enables thorough monitoring and analysis of user interactions and responses, leading to more accurate adaptation of the system's behavior.

In further embodiments, the processor employs natural language processing, computer vision algorithms, and movement analysis to process the multimodal input data. This multi-faceted analysis provides detailed insights into user states and behaviors, enabling more precise system responses.

In additional embodiments, the processor combines analyzed data using multimodal fusion algorithms, creating a comprehensive understanding of user states and needs. This integration of multiple data streams enhances the accuracy and reliability of the system's adaptive responses.

In yet further embodiments, the system employs machine learning models including neural networks, reinforcement learning algorithms, and classification algorithms. These computational methods enable sophisticated pattern recognition and behavioral adaptation capabilities.

In some embodiments, the virtual companion data includes parameters for appearance, animation, interaction, and communication. This parameterization allows for flexible and customizable virtual companion behaviors that can be adjusted based on user needs and preferences.

In further embodiments, the virtual reality module renders and animates the virtual companion according to these parameters, enabling dynamic modifications of companion behaviors and outputs. This real-time adaptation creates more natural and responsive interactions.

In additional embodiments, the interactive virtual environment includes configurable three-dimensional spaces, interactive objects, and task-specific elements. These components enable creation of varied and practical training scenarios.

In some embodiments, the backend platform implements data analytics engines, user profile management, and content management systems. These features facilitate comprehensive data analysis and system administration.

In further embodiments, the backend platform utilizes distributed data storage, real-time synchronization, and load balancing mechanisms. This infrastructure ensures reliable system operation and efficient data management.

In additional embodiments, the system incorporates quantum encryption modules and privacy-preserving computation capabilities. These security measures protect sensitive user data while maintaining system functionality.

In yet further embodiments, the processor implements federated learning algorithms and edge computing capabilities. These technologies enable efficient distributed processing and improved system responsiveness.

### BRIEF DESCRIPTION OF THE DRAWINGS

Various embodiments of the invention are disclosed in the following detailed description and accompanying drawings.

FIG. 1 illustrates an example system architecture showing the hierarchical arrangement of user interaction, AI processing, and backend infrastructure components of the adaptive virtual reality assistance system.

FIG. 2 illustrates an example real-time interaction between a user and the Virtual Reality Artificial Intelligence Companion within an adaptive virtual environment during a training task.

FIG. 3 illustrates an example reinforcement learning framework showing how the system continuously refines its responses based on user interaction data and performance metrics.

FIG. 4 illustrates an example service provider backend interface that enables caregivers and trainers to monitor user progress, adjust training parameters, and provide interventions in real-time or asynchronously.

FIG. 5 illustrates an example emotional intelligence feedback system showing how the system detects, processes, and responds to user emotional states through various input and output mechanisms.

FIG. 6 illustrates an example quantum-safe data protection architecture demonstrating the system's secure data collection, processing, and access control mechanisms.

FIG. 7 illustrates an example hybrid workflow system that integrates real-time and asynchronous training capabilities within a unified virtual environment.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “first,” “second,” and the like are used to distinguish different elements or features, but these elements or features should not be limited by these terms. A first element or feature described can be referred to as a second element or feature and vice versa without departing from the teachings of the present disclosure.

The term “multimodal input data” refers to any combination of data types collected from different sensing modalities that provide information about a user's state, behavior, or interactions. This includes, but is not limited to, audio data from microphones, visual data from cameras, motion data from accelerometers or position sensors, and biometric data from physiological sensors. In one example implementation, multimodal input data may comprise voice recordings, facial expression video, hand movement tracking, and heart rate measurements collected simultaneously during user interaction with the system.

The term “virtual companion” refers to an artificial intelligence-driven entity rendered within the virtual environment that interacts with the user. This includes, but is not limited to, avatars, animated characters, or abstract visual representations capable of providing feedback and guidance. In one example implementation, the virtual companion may be rendered as a humanoid character that can gesture, speak, and move within the virtual space while responding to user actions and emotional states.

The term “processed user state data” refers to the output of computational analysis performed on multimodal input data to determine user conditions, behaviors, or needs. This includes, but is not limited to, detected emotional states, task progress metrics, interaction patterns, and physiological status information. In one example implementation, processed user state data may comprise real-time measurements of user stress levels derived from voice analysis, facial expression recognition, and heart rate variability calculations.

The term “interactive virtual environment” refers to a computer-generated three-dimensional space that responds to and can be modified by user actions and system parameters. This includes, but is not limited to, simulated physical spaces, abstract environments, or mixed reality scenarios that combine virtual and real-world elements. In one example implementation, the interactive virtual environment may be a simulated shopping center with physics-based object interactions, realistic lighting, and spatially-oriented audio.

The term “behavioral models” refers to computational frameworks that define how the virtual companion and environment respond to processed user state data. This includes, but is not limited to, machine learning models, rule-based systems, or hybrid approaches that determine appropriate system responses. In one example implementation, behavioral models may comprise neural networks trained on interaction data to predict optimal virtual companion responses based on detected user emotional states and task progress.

The term “backend platform” refers to the distributed computing infrastructure that supports data processing, storage, and transmission for the system. This includes, but is not limited to, cloud-based servers, edge computing devices, or hybrid architectures that manage system operations. In one example implementation, the backend platform may comprise a network of distributed servers running containerized services for data analytics, user profile management, and content delivery.

In various implementations, the virtual reality module may be realized through different hardware configurations, including but not limited to: head-mounted displays, augmented reality glasses, smartphone-based viewers, or projection-based systems. The data acquisition module may utilize various sensor technologies, including but not limited to: RGB cameras, depth sensors, microphone arrays, electrodermal activity sensors, or eye-tracking devices.

The system may employ various encryption and security protocols for data protection, including but not limited to: quantum key distribution, post-quantum cryptography, blockchain-based verification, or homomorphic encryption. Communication between system components may be implemented using various protocols, including but not limited to: WebRTC, WebSocket, MQTT, or custom real-time streaming protocols.

### Description of Drawings

The present invention provides a system that addresses the limitations of existing assistive technologies through an integrated approach to real-time adaptive assistance. Traditional systems typically offer static or pre-programmed responses that fail to accommodate the dynamic needs of users. In contrast, this invention continuously processes multimodal input data to generate adaptive responses through both a virtual companion and an interactive virtual environment.

The system overcomes prior art limitations by implementing a comprehensive data acquisition and processing architecture that enables genuine real-time adaptation. Unlike existing solutions that may collect limited types of user input or process data with significant latency, this invention simultaneously processes multiple data streams from various sensors to create an accurate and current understanding of user state. This multimodal approach provides a more complete picture of user needs than systems relying on single input types such as voice or gesture recognition alone.

The virtual companion component of the system represents a significant advancement over existing AI assistants by combining sophisticated behavioral models with real-time rendering in an interactive virtual environment. While prior systems may offer basic virtual assistance or separate virtual reality experiences, this invention integrates these elements into a cohesive system where both the companion and environment adapt dynamically to user needs. The companion's responses are not limited to pre-defined scripts or basic decision trees but are generated through advanced processing of user state data and behavioral models.

The system's backend platform provides robust support for data processing and storage while enabling secure remote access and monitoring. This addresses the common limitation of existing systems that either operate in isolation or provide limited remote functionality. The distributed architecture allows for sophisticated data analysis and model updates while maintaining responsive local operation through efficient processing and communication protocols.

Through this integrated approach, the invention provides a more effective and adaptable solution for assistance than existing technologies. The system's ability to process multiple input streams, generate sophisticated responses, and maintain secure distributed operation enables it to better serve user needs across a wide range of applications and scenarios. The following detailed description provides specific implementations of the system's components and their operation.

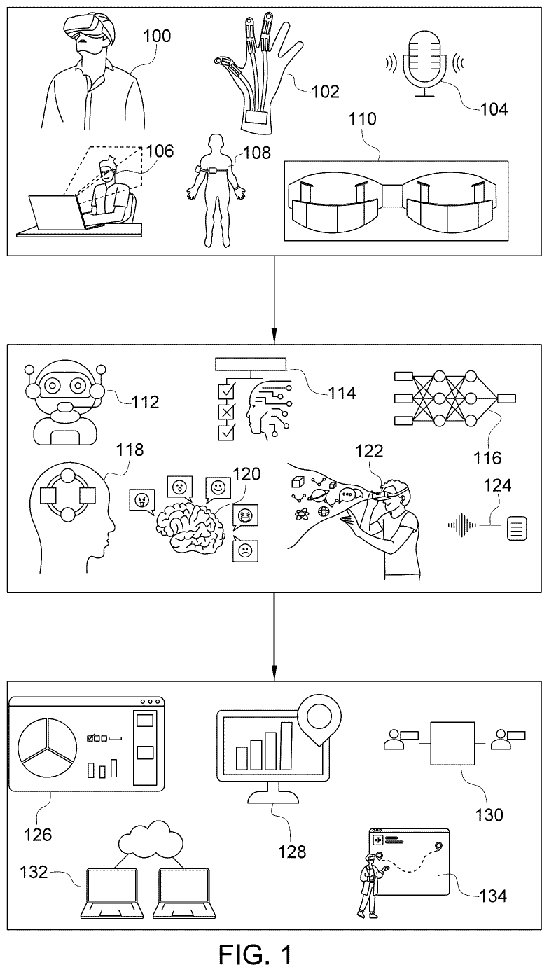

Referring to FIG. 1, a system architecture is shown illustrating the hierarchical arrangement and data flow between components of an adaptive virtual reality assistance system. The architecture comprises three main layers arranged vertically to represent the logical flow of data and interactions.

At the top of FIG. 1, the User Interaction Layer includes various input and interface devices. A virtual reality headset 100 is worn by the user to provide immersive visual feedback, though in some implementations the headset may be replaced by augmented reality glasses or other display devices. The system includes haptic feedback devices 102, which may comprise gloves, controllers, or other wearable sensors that provide tactile feedback to the user. A microphone 104 captures voice commands and speech input, which may in some implementations comprise an array of microphones for enhanced audio capture and directional processing. A facial expression and eye-tracking camera 106 monitors the user's emotional state and gaze direction, though alternative implementations may use different types of optical sensors or multiple cameras for enhanced tracking accuracy. The system includes physiological sensors 108, such as heart rate monitors or electrodermal activity sensors, which may be integrated into wearable devices or standalone components. A user avatar 110 represents the user's presence within the virtual environment, though the specific appearance and capabilities of this avatar may be customized or adapted based on the application.

The middle section of FIG. 1 shows the AI Processing Layer, centered around the Virtual Reality Artificial Intelligence Companion (VRAIC) 112. The VRAIC 112 acts as the core AI-driven assistant, processing inputs and generating adaptive responses. A reinforcement learning model 114 continuously refines the system's guidance based on user interactions, though alternative machine learning approaches may be employed. A multimodal input fusion module 116 aggregates and processes data from the various input sensors, implementing sophisticated algorithms to combine and analyze multiple data streams. An adaptive task guidance engine 118 modifies instructions and feedback based on processed user state data, while an emotional intelligence processing module 120 analyzes user emotional states to adjust system responses. A virtual environment generator 122 creates and modifies the immersive 3D environment, which may be implemented using various rendering engines and environmental modeling approaches. A speech-to-action conversion module 124 processes voice commands to trigger appropriate system responses.

The bottom section of FIG. 1 depicts the Backend & Data Infrastructure layer. A service provider dashboard 126 enables remote monitoring and intervention, which may be accessed through web browsers or dedicated applications. A data logging and progress tracker 128 maintains detailed records of user interactions and system adaptations. A quantum-safe data security module 130 protects all communications using advanced encryption protocols, though other security approaches may be implemented based on specific requirements. A cloud-based training library 132 stores instruction modules and training data, which may be distributed across multiple servers for improved reliability and access speed. A real-time caregiver intervention system 134 enables remote assistance and monitoring, though the specific capabilities may vary based on implementation requirements.

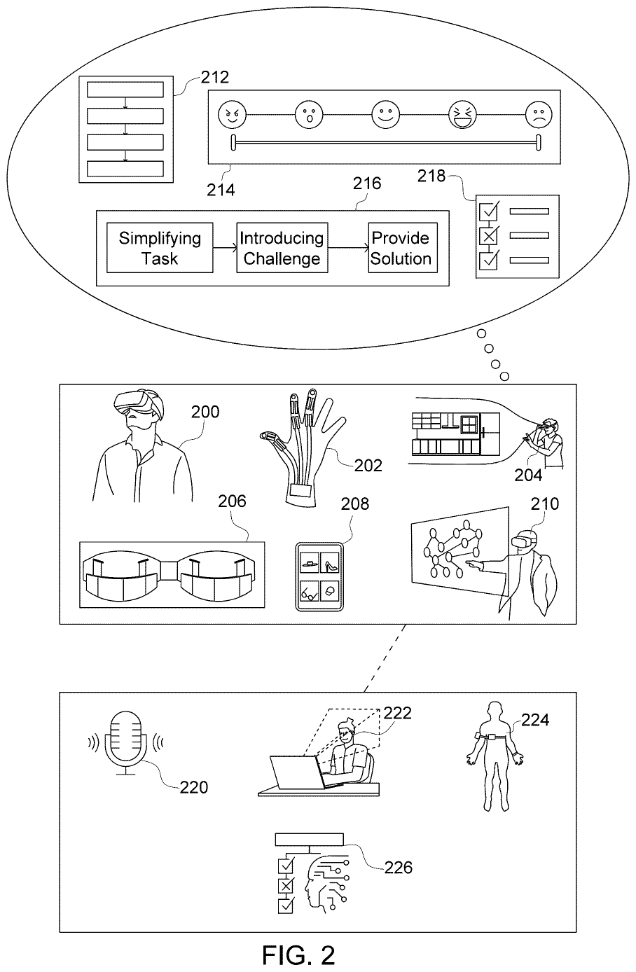

Referring to FIG. 2, a detailed view is shown of user interaction with the Virtual Reality Artificial Intelligence Companion (VRAIC) system during a training task. The figure illustrates the real-time interaction between various system components during task execution.

In the foreground of the figure, a user wearing a virtual reality headset 200 is shown engaged in a training task. The headset 200 may comprise various types of head-mounted displays, including but not limited to standalone VR devices, smartphone-based headsets, or augmented reality glasses. The user wears haptic feedback gloves 202 for object interaction, though in some implementations these may be replaced by motion-sensing controllers or other haptic devices that provide tactile feedback during virtual object manipulation.

The user is positioned within a virtual task workspace 204, which provides a dynamic training environment. While the figure shows one configuration, the workspace 204 may be customized to represent various scenarios such as kitchens, retail spaces, offices, or other training-relevant environments. Within this workspace, a VRAIC avatar 206 is rendered to provide real-time assistance. The avatar 206 may take various forms depending on user preferences and application requirements, from realistic humanoid representations to abstract visual indicators.

Interactive virtual objects 208 are positioned within the workspace for task completion. These objects are rendered with physics-based properties and may represent various items relevant to the specific training scenario. The user's hands are represented through virtual hand models 210 that precisely mirror real-world gestures and movements, though alternative embodiments may employ different interaction paradigms such as ray-casting or gesture recognition.

Floating in the virtual space, an adaptive instruction display 212 provides dynamic task guidance. The display 212 shows step-by-step instructions that update based on user performance and may be configured to present information in various formats including text, icons, or animated demonstrations. An emotional state indicator 214 provides visual feedback about the system's assessment of user emotional state, which may be represented through various visual metaphors or color coding schemes.

A contextual task adjustment mechanism 216 modifies task parameters in real-time, with modifications visualized through environmental changes or instruction updates. A task completion tracker 218 monitors and displays progress, which may be implemented as traditional progress bars, checklists, or more sophisticated visualization methods.

In the background, several processing modules are represented. A voice command processing module 220 interprets speech input, while facial and eye-tracking sensor data streams 222 monitor user expressions and gaze direction. Physiological sensor data streams 224 collect biometric information, which may include various physiological markers depending on the sensors employed. A reinforcement learning-based task adaptation engine 226 continuously processes this multimodal input data to refine the system's responses and adapt training parameters.

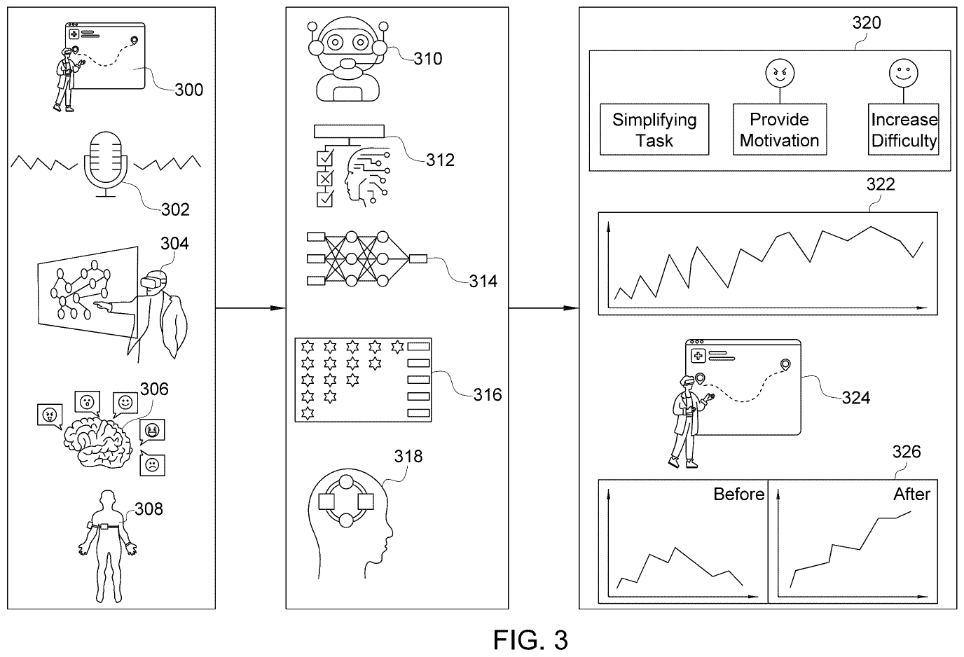

Referring to FIG. 3, a reinforcement learning framework is shown that illustrates the continuous refinement of the system's adaptive responses through user interaction data. The figure is organized into three vertical sections representing input processing, decision making, and output generation.

On the left side of the figure, the Input Layer displays the collection of user interaction data. A user 300 is shown performing tasks within the virtual environment, which may encompass various scenarios such as vocational training, daily living skills, or educational activities. A voice input data stream 302 captures and processes spoken communication, which may include both direct commands and natural conversation. The gesture and motion tracking system 304 monitors physical movements and interactions, which may be captured through various sensing technologies including but not limited to optical tracking, inertial measurement units, or electromagnetic sensors. Facial expression and eye-tracking data 306 are collected through specialized cameras and processing algorithms, while physiological sensor data 308 is gathered from various biometric monitoring devices that may be integrated into wearables or standalone units.

The center of the figure depicts the Core Decision Layer, where the Virtual Reality Artificial Intelligence Companion (VRAIC) 310 serves as the central processing hub. The reinforcement learning algorithm 312 continuously processes interaction data to refine its response models, which may employ various approaches such as deep Q-learning, policy gradient methods, or hybrid architectures. A multimodal data processing module 314 integrates the diverse input streams, employing fusion algorithms to create comprehensive state representations. The task performance evaluation module 316 analyzes user actions and outcomes, which may include multiple assessment metrics depending on the specific training scenario. An adaptive task modification module 318 implements real-time adjustments to training parameters based on processed data and learned patterns.

The right side of the figure shows the Output Layer, where system responses and adaptations are generated. The real-time adaptation output 320 represents immediate system responses to user actions and states, which may take various forms including environmental modifications, instruction adjustments, or feedback delivery. A long-term skill progression model 322 maintains historical performance data and learning trajectories, which may be visualized through various analytical tools and interfaces. The caregiver intervention and feedback loop 324 enables authorized personnel to monitor and modify training parameters, though the specific capabilities may vary based on implementation requirements. A task completion trend graph 326 provides visual representation of user progress over time, which may be displayed through various charting and visualization methods.

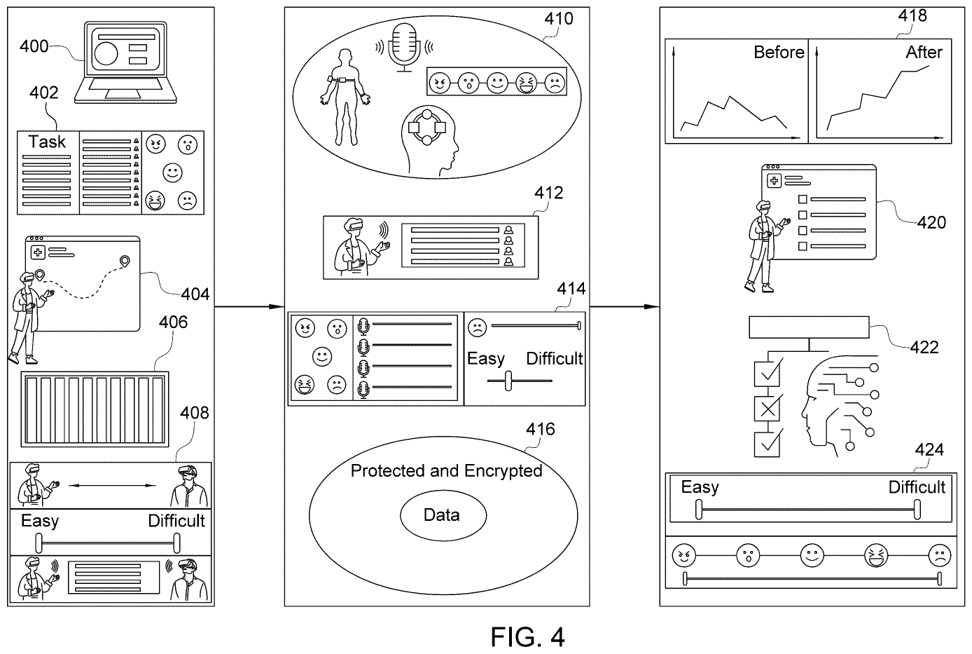

Referring to FIG. 4, a comprehensive service provider backend interface is shown that enables monitoring, management, and intervention in user training sessions. The interface is organized into three main sections that facilitate different aspects of caregiver interaction with the system.

On the left side of the figure, the User Interface Elements section displays the primary interaction points for service providers. A caregiver workstation 400 provides the main access point to the system, which may be implemented through various devices including desktop computers, tablets, or mobile devices with appropriate security protocols. A user performance dashboard 404 presents real-time metrics and analytics, which may be customized to display various performance indicators depending on training objectives and user needs. A session scheduling and management module 408 enables coordination of training activities, which may incorporate various scheduling algorithms and conflict resolution mechanisms. A customizable task library 412 contains training modules that may be generated through AI systems or created manually by service providers. Live monitoring and intervention controls 416 provide real-time session oversight capabilities, which may be implemented through various interface paradigms including split-screen views, overlay controls, or dedicated monitoring panels.

The center of the figure shows the Backend System Components that process and manage data. A real-time data stream visualization 420 presents ongoing session information, which may be displayed through various graphical representations depending on data type and analysis requirements. An adaptive training settings module 424 provides fine-grained control over system behavior, which may include various parameter adjustment capabilities based on implementation requirements. An emotion and engagement analysis module 428 processes multimodal user state data, which may employ various analysis algorithms depending on input types and detection requirements. A data security and user privacy module 432 implements protective measures that may include various encryption protocols, access control mechanisms, and compliance monitoring systems.

The right side of the figure illustrates the Intervention & Analytics components. A performance progress graph 436 displays longitudinal data, which may be visualized through various charting methods depending on the metrics being tracked. A caregiver notes and recommendations panel 440 enables documentation and feedback, which may be implemented with various text entry and formatting capabilities. An AI-generated training adjustments display 444 shows automated system recommendations, which may be presented through various interface elements depending on the type of adjustment being proposed. A task complexity adjustment tool 448 provides manual control over training parameters, which may be implemented through various interface controls depending on the parameters being adjusted.

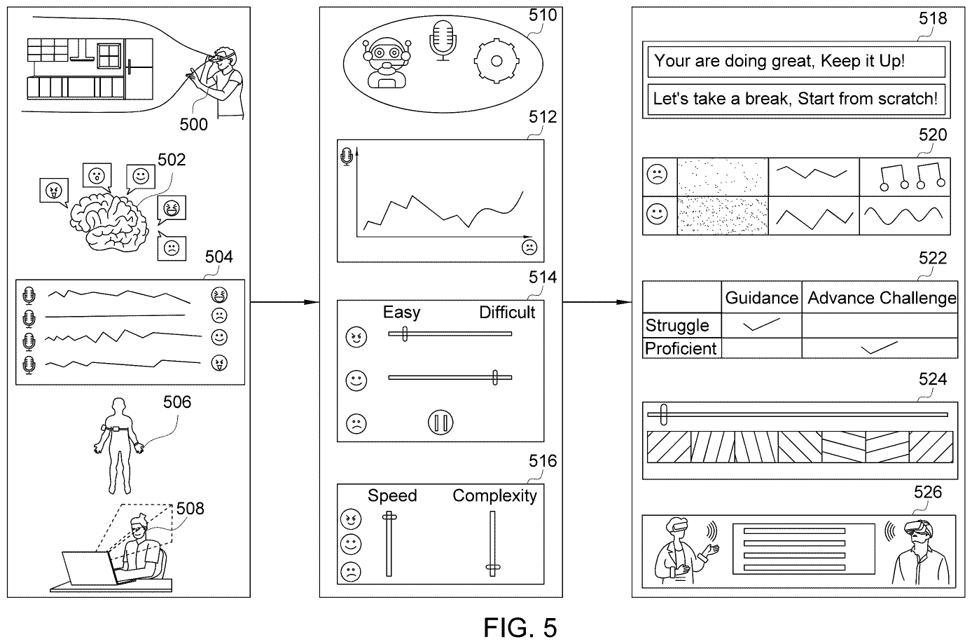

Referring to FIG. 5, an adaptive emotional intelligence feedback system is shown that illustrates how the system detects, processes, and responds to user emotional states in real-time. The figure is organized into three vertical sections representing emotional input detection, processing, and response generation.

On the left side of the figure, the Input Layer shows the collection and initial processing of emotional state data. A user 500 is shown engaging with the virtual environment, which may be rendered through various display technologies depending on implementation requirements. A facial expression analysis module 502 employs computer vision algorithms to detect emotional indicators, which may utilize various neural network architectures optimized for facial feature detection and classification. A voice tone and sentiment detection module 504 analyzes audio input for emotional content, which may incorporate various speech processing algorithms including spectral analysis and natural language processing. Physiological sensor data input 506 collects biometric measurements, which may be gathered through various sensing technologies such as photoplethysmography, electrodermal activity sensors, or respiratory monitors. An eye-tracking and attention monitoring system 508 tracks gaze patterns and focus, which may employ various tracking technologies including infrared sensors or camera-based systems.

The center of the figure depicts the Adaptive AI Components responsible for emotional processing and decision making. The Virtual Reality Artificial Intelligence Companion (VRAIC) 510 serves as the central processing hub, coordinating emotional analysis and response generation. An emotional intelligence processing engine 512 integrates multiple data streams to determine emotional state, which may employ various fusion algorithms and machine learning models for emotional state classification. An adaptive response generator 514 determines appropriate system responses, which may include various decision-making algorithms and behavioral models. A task pacing and complexity adjustment module 516 modifies training parameters based on emotional state data, which may implement various adaptation strategies depending on the training context and user needs.

The right side of the figure illustrates the Output Layer where system responses are generated and delivered. An adaptive AI dialogue and encouragement message system 518 generates contextually appropriate feedback, which may employ various natural language generation techniques. Environmental adaptation controls 520 modify the virtual environment, which may include various parameters such as lighting, sound, and visual complexity. A task simplification or challenge addition module 522 adjusts difficulty levels, which may implement various progression algorithms based on user performance and emotional state. A visual emotional state indicator 524 provides feedback about detected emotions, which may be implemented through various visualization techniques. A caregiver alert system 526 enables automated notification of support personnel when needed, which may incorporate various triggering conditions and notification methods.

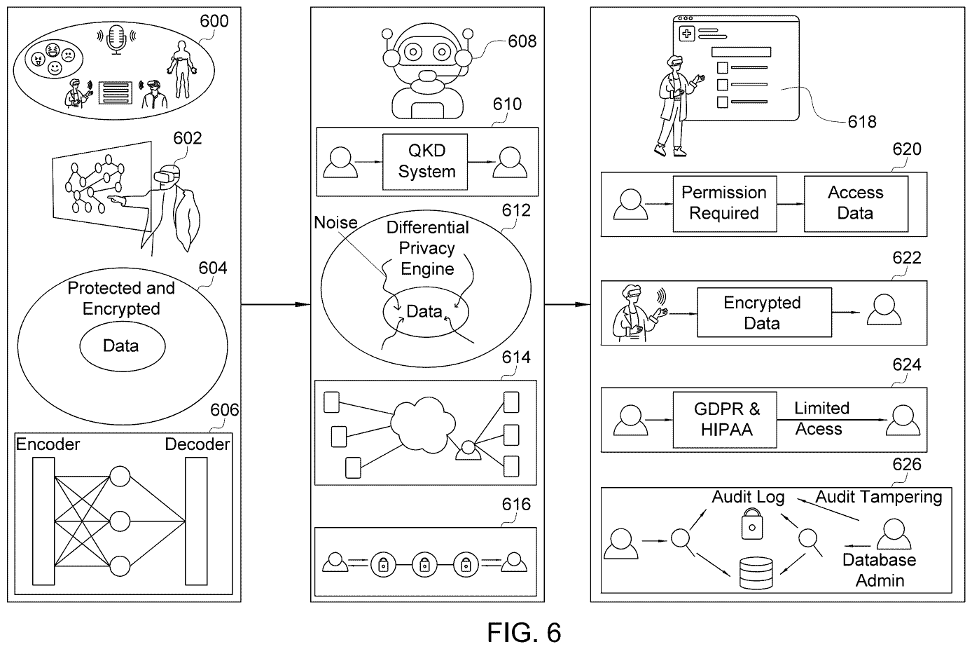

Referring to FIG. 6, a quantum-safe data protection and privacy model is shown that illustrates the system's secure data handling architecture. The figure is organized into three vertical sections representing data collection and encryption, secure processing, and protected access layers.

On the left side of the figure, the Input Layer shows the initial data collection and protection mechanisms. User data input sources 600 represent the collection points for various types of user information, which may include audiovisual recordings, biometric measurements, and interaction logs. A local AI processing unit 602 is integrated within the VR headset, which may employ various edge computing architectures to perform initial data processing and encryption. An end-to-end quantum encryption layer 604 secures data transmission, which may utilize various quantum-resistant cryptographic protocols depending on implementation requirements. A user identity protection and anonymization module 606 processes personal information, which may implement various techniques such as data masking, tokenization, or differential privacy algorithms.

The center of the figure depicts the Data Handling & Processing Layer where secure computation occurs. A VRAIC secure server 608 manages encrypted processing operations, which may employ various secure computation techniques including homomorphic encryption or secure multi-party computation. A quantum key distribution system 610 manages encryption keys, which may implement various QKD protocols depending on security requirements and network infrastructure. A differential privacy engine 612 protects against inference attacks, which may employ various noise injection algorithms while maintaining data utility. A federated learning model 614 enables distributed training, which may implement various federated learning architectures depending on system requirements. A zero-knowledge proof authentication system 616 verifies user identity and permissions, which may utilize various ZKP protocols depending on security requirements.

The right side of the figure shows the Secure Data Access Layer controlling authorized access to system data. A service provider encrypted dashboard 618 presents protected information, which may implement various access control and encryption mechanisms. A user-consent-based access control system 620 manages permissions, which may employ various consent management and verification protocols. A real-time session data monitoring system 622 enables secure observation of user progress, which may implement various data filtering and protection mechanisms. A GDPR and HIPAA compliance framework 624 ensures regulatory adherence, which may incorporate various compliance monitoring and enforcement mechanisms. An audit log and breach detection system 626 monitors system security, which may employ various anomaly detection and logging protocols.

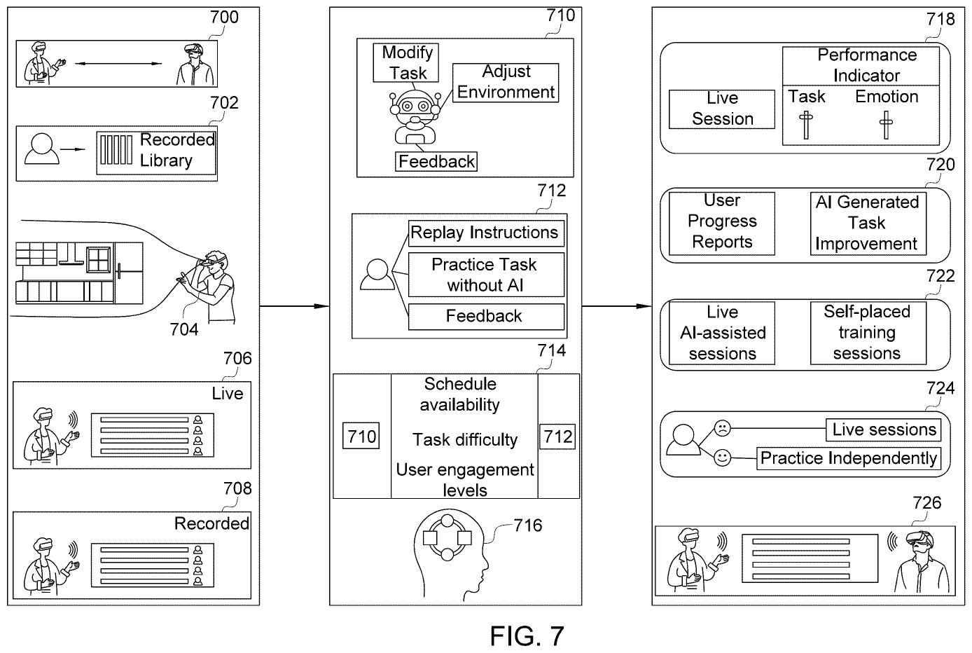

Referring to FIG. 7, a hybrid workflow system is shown that integrates real-time and asynchronous training capabilities within the virtual environment. The figure is organized into three vertical sections representing user interaction modes, adaptive training processes, and monitoring capabilities.

On the left side of the figure, the User Interaction Layer depicts the two primary training pathways. A user engaged in real-time training 700 is shown actively participating in a live session, which may utilize various VR display and interaction technologies depending on implementation requirements. Another user representation 702 demonstrates asynchronous self-paced training, which may incorporate different types of pre-recorded or AI-generated content. A VR-based task simulation environment 704 provides the virtual space for both training modes, which may be configured to represent various real-world scenarios. The VRAIC AI instructor appears in two modes: a live mode 706 providing active, real-time guidance, and a pre-recorded mode 708 offering structured, self-paced instruction, each of which may implement different interaction paradigms based on the training context.

The center of the figure shows the Adaptive Training Engine components that manage the hybrid learning experience. A real-time training session module 710 coordinates live interactions, which may employ various adaptation algorithms to modify task parameters dynamically. An asynchronous training module 712 manages self-paced learning experiences, which may implement different types of automated evaluation and feedback mechanisms. A session switching mechanism 714 enables smooth transitions between training modes, which may utilize various criteria and algorithms to determine optimal timing for transitions. A reinforcement learning integration system 716 processes performance data from both modes, which may implement various learning algorithms to refine training approaches over time.

The right side of the figure illustrates the Oversight & Performance Tracking Layer for monitoring and assessment. A service provider dashboard 718 enables real-time session monitoring, which may present various performance metrics and interaction data. A self-paced session review panel 720 displays asynchronous training results, which may implement different visualization and analysis tools. A hybrid performance analytics dashboard 722 provides comparative analysis across training modes, which may employ various statistical and machine learning techniques for performance assessment. An AI recommendation system 724 suggests optimal training pathways, which may utilize various prediction algorithms and decision models. A trainer intervention tool 726 enables manual oversight and adjustment, which may implement various control and communication mechanisms.

The arrangement of these components facilitates seamless integration between real-time and asynchronous training modes, with comprehensive monitoring and adaptation capabilities supporting both approaches. The system's ability to combine and coordinate different training modalities enables flexible and personalized learning experiences that can adapt to user needs and preferences.

### Controller/Processor Components

A processor or controller as described herein may include any suitable type of computing device, such as a central processing unit (CPU), microcontroller, graphics processing unit (GPU), system on a chip (SoC), or digital signal processor (DSP). It may operate with one or more cores and may be configured to execute the functions described in this disclosure.

The processor may be operably connected to one or more memory devices, such as random access memory (RAM), read-only memory (ROM), flash storage, or solid-state drives (SSD). These memory devices store computer-readable instructions that, when executed by the processor, perform the methods described. The processor and memory communicate via data buses or other suitable communication pathways.

The computing device may also include input/output (I/O) devices, such as a touchscreen, mouse, keyboard, display, or speaker, to facilitate interaction with users or other systems. Additionally, it may include a network interface, such as a wired or wireless communication module, for connecting to networks.

Control logic or software instructions may be stored in memory and executed by the processor to implement specific functionalities. This logic may be modular, consisting of software components, processes, or functions that work together to perform the operations described herein.

The described computing operations involve the manipulation of data represented as electrical, optical, or magnetic signals stored or transferred within the system. These operations are machine-executed and do not require manual intervention, though they may interface with human operators through appropriate user interfaces.

The systems and methods described are not limited to any particular hardware configuration or programming language and may be implemented on general-purpose or specialized computing devices.

### Conclusion

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the ... of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system comprising:
a data acquisition module configured to receive multimodal input data from one or more sensors;
a virtual reality module configured to generate an interactive virtual environment;
a processor coupled to the data acquisition module and the virtual reality module, the processor configured to:
process the multimodal input data to generate processed user state data;
generate, based on the processed user state data, virtual companion data defining behavior parameters for a virtual companion within the interactive virtual environment;
dynamically modify at least one parameter of the interactive virtual environment based on the processed user state data;
transmit the virtual companion data and the at least one modified parameter to the virtual reality module;
a memory coupled to the processor and configured to store:
the multimodal input data;
the processed user state data;
one or more behavioral models used by the processor to generate the virtual companion data;
configuration data for the interactive virtual environment;
a backend platform comprising:
a second processor configured to receive and process data from the memory;
a communication interface configured to transmit processed data to one or more remote devices; and
a second memory configured to store the processed data; and
wherein the virtual reality module is further configured to:
render the virtual companion within the interactive virtual environment according to the virtual companion data; and
modify the interactive virtual environment according to the at least one modified parameter.

2. The system of claim 1, wherein the multimodal input data comprises:
audio data captured by one or more microphones;
visual data captured by one or more cameras;
motion data captured by one or more motion sensors; and
biometric data captured by one or more biometric sensors.

3. The system of claim 2, wherein the processor is further configured to:
analyze the audio data using natural language processing to detect speech content and voice characteristics;
analyze the visual data using computer vision algorithms to detect facial expressions and gestures;
analyze the motion data to detect movement patterns; and
analyze the biometric data to detect physiological parameters.

4. The system of claim 3, wherein the processor is further configured to:
combine the analyzed audio data, visual data, motion data, and biometric data using multimodal fusion algorithms to generate the processed user state data.

5. The system of claim 4, wherein the processor employs machine learning models to process the multimodal input data, the machine learning models comprising:
neural networks configured for pattern recognition;
reinforcement learning algorithms configured for behavioral adaptation; and
classification algorithms configured for state detection.

6. The system of claim 1, wherein the virtual companion data comprises:
appearance parameters defining visual characteristics of the virtual companion;
animation parameters defining movement characteristics of the virtual companion;
interaction parameters defining behavioral responses of the virtual companion; and
communication parameters defining output modalities of the virtual companion.

7. The system of claim 6, wherein the virtual reality module is configured to:
render the virtual companion according to the appearance parameters;
animate the virtual companion according to the animation parameters;
modify virtual companion behaviors according to the interaction parameters; and
generate virtual companion outputs according to the communication parameters.

8. The system of claim 7, wherein the processor is configured to:
continuously update the virtual companion data based on changes in the processed user state data; and
transmit the updated virtual companion data to the virtual reality module in real-time.

9. The system of claim 8, wherein the processor employs adaptive algorithms to:
modify the virtual companion's behavioral responses based on historical interaction patterns stored in the memory; and
adjust the virtual companion's communication style based on effectiveness metrics derived from the processed user state data.

10. The system of claim 1, wherein the interactive virtual environment comprises:
configurable three-dimensional spaces;
interactive virtual objects;
environmental parameters controlling ambient characteristics; and
task-specific elements for simulated activities.

11. The system of claim 10, wherein the processor is configured to:
modify spatial arrangements of the virtual objects;
adjust environmental parameters;
alter complexity levels of simulated activities; and
generate new task-specific elements based on the processed user state data.

12. The system of claim 11, wherein the virtual reality module implements:
physics-based interactions between virtual objects;
realistic lighting and shadow effects;
spatial audio processing; and
haptic feedback generation.

13. The system of claim 12, wherein the virtual reality module is configured to:
synchronize environmental modifications across multiple connected devices; and
maintain consistent virtual environment states during real-time modifications.

14. The system of claim 1, wherein the backend platform further comprises:
data analytics engines for processing historical interaction data;
user profile management systems;
content management systems for virtual environment assets; and
authentication and authorization systems.

15. The system of claim 14, wherein the backend platform implements:
distributed data storage across multiple servers;
real-time data synchronization protocols;
automated backup systems; and
load balancing mechanisms.

16. The system of claim 15, wherein the communication interface supports:
encrypted data transmission;
real-time streaming protocols;
peer-to-peer connections; and
web-based API access.

17. The system of claim 16, wherein the backend platform is configured to:
generate analytics reports;
manage remote system configurations;
coordinate multi-user sessions; and
facilitate data exchange with external systems.

18. The system of claim 1, further comprising:
quantum encryption modules for secure data transmission;
biometric authentication systems;
blockchain-based data verification systems; and
privacy-preserving computation modules.

19. The system of claim 18, wherein the quantum encryption modules implement:
quantum key distribution protocols;
post-quantum cryptographic algorithms;
quantum-resistant authentication mechanisms; and
quantum random number generation.

20. The system of claim 1, wherein the processor implements:
federated learning algorithms for distributed model training;
edge computing capabilities for local data processing;
adaptive compression algorithms for data transmission; and
dynamic resource allocation mechanisms.
